(19) United States
(12) Patent Application Publication
(10) Pub. No.: US 2024/0043208 A1
(43) Pub. Date: Feb. 8, 2024

(54) BLOCK STORAGE ARRANGEMENT AND METHOD FOR OPERATING A BLOCK STORAGE ARRANGEMENT

(71) Applicant: Jungheinrich Aktiengesellschaft, Hamburg (DE)

(72) Inventors: Michael BECKER, Hainburg (DE); Timm MORAWIETZ, Tholey-Überroth (DE); Jörg CAVELIUS, Bad Vilbel (DE)

(73) Assignee: Jungheinrich Aktiengesellschaft, Hamburg (DE)

(21) Appl. No.: 18/229,445

(22) Filed: Aug. 2, 2023

(30) Foreign Application Priority Data
Aug. 5, 2022 (EP) 22188920.7

(51) Int. Cl. B65G 1/04; B65G 57/30; B65G 47/51

(52) U.S. Cl. CPC B65G 1/0478; B65G 57/301; B65G 47/5104; B65G 2203/0258; B65G 2203/041

(57) ABSTRACT

A block storage arrangement that includes multiple container receiving chambers; at least one container; and at least one loading vehicle, which is movable in a loading direction to the multiple container receiving chambers, includes a container receiver for the at least one container. Upstream of the multiple container receiving chambers in the loading direction, a container loading center of gravity of the at least one container is determined.

### CROSS-REFERENCE TO RELATED APPLICATION

This application claims priority under 35 U.S.C. § 119(a) to Europe Application No. 22 18 8920.7 filed Aug. 5, 2022, the disclosure of which is expressly incorporated by reference herein in its entirety.

### BACKGROUND

### 1. Field of the Invention

Embodiments relate to a block storage arrangement with multiple container receiving chambers, at least one container and at least one loading vehicle, which can be moved in a loading direction to the container receiving chambers and has a container receiver for the at least one container.

Furthermore, embodiments relate to a method for operating a block storage arrangement with multiple container receiving chambers, at least one loading vehicle, which is moved in a loading direction to the container receiving chambers and with which at least one container is transported into a container receiving chamber.

### 2. Discussion of Background Information

In a block storage arrangement, also referred to as a “stacking storage arrangement,” containers can be mounted in a stacked form. A container receiving chamber is provided for each of such container stacks. Since the containers are located on top of one another in a container receiving chamber, the available space is fully utilized in the direction of gravity. The container receiving chambers can also be arranged in a relatively dense manner, such that the available space can also be used very well transversely to the direction of gravity.

The containers serve to receive objects. The objects can, for example, be stored in a container in a work station. Subsequently, the container is moved into a container receiving chamber. If the object is to be removed again from the container, the container must be removed from the container receiving chamber and brought into the work station. There, access to the container from the outside is possible.

The stacks formed from the containers in the container receiving chambers can have a considerable height. The higher a stack of containers, the greater is the risk that the stack tends to tilt and, in the extreme case, topples.

### SUMMARY

Embodiments are directed to minimizing risks during the operation of a block storage arrangement.

According to embodiments, a block storage arrangement of the type mentioned at the beginning includes a device for determining a container loading center of gravity arranged upstream of the container receiving chambers in the loading direction.

With the device for determining a container loading center of gravity, it is possible to obtain information regarding how a load is distributed in a container within certain limits. As explained above, the load consists of one or more objects that are to be stored in the container. If the container loading center of gravity is arranged very far outside the center, a warning signal can then be generated, for example, with the aid of the device for determining a container loading center of gravity, such that an operator who has stored the object or objects in the container has the option of checking the loading of the container.

The device for determining a container loading center of gravity preferably determines a loading eccentricity. Thus, a measure that can be used as a criterion as to whether or not the center of gravity of the load is still arranged within permissible limits is available.

Preferably, the device for determining a container loading center of gravity determines a mass of the container. This provides an additional criterion for minimizing the risk of a container stack tilting in a container receiving chamber. A container with a large mass can then be arranged relatively far down in a stack, for example, such that an off-center storing center of gravity is less critical here than if the container with the same mass were arranged further up in the stack.

Preferably, the device for determining a container loading center of gravity is connected to a control device, which selects a container receiving chamber as a function of an output signal from the device for determining a container loading center of gravity. Such an embodiment is particularly advantageous if the container is inserted into a container receiving chamber from below and removed from the container receiving chamber downward. In such a case, there is a loading chamber below the container receiving chambers in the direction of gravity, in which the loading vehicle can be moved. In order to hold a container or a stack of containers in a container receiving chamber, a holding device is arranged between the respective container receiving chamber and the loading chamber. This holding device has, for example, multiple holding pawls or other parts on which the container or the container stack rests. If one is now able to determine the container loading center of gravity, one can prevent multiple containers from being stacked on top of one another in a container receiving chamber, with which the container loading center of gravity is in the same direction away from the center point of the container. In such a case, an impermissibly high load would result on a part of the holding device or on a part of the lowermost container of a stack, while another part of the holding device is subjected to a much lower load. Therefore, the device for determining a container loading center of gravity can be used to avoid the risk of overloading the holding device.

In a preferred embodiment, it is provided that the device for determining a container loading center of gravity has at least three weighing devices arranged at a distance from one another. The weighing devices can be designed as load cells, for example. By using at least three such weighing devices, it is easy to determine weight forces exerted by the container on the weighing devices at three different positions. Such weight forces can then be used to obtain a statement regarding the container loading center of gravity.

Preferably, the device for determining a container loading center of gravity has four weighing devices, which are assigned to corners of the container. With four weighing devices assigned to precisely defined positions, it is relatively easy to record the center of gravity of the container load.

Preferably, the device for determining a container loading center of gravity is arranged in a work or transfer station or on the loading vehicle. Thus, the device for determining a container loading center of gravity is arranged where a change in the loading of the container occurs. One can then perform the determination of the container loading center of gravity if an object is stored in or removed from a container. It is then also possible to determine the mass and center of gravity of a container when it is stored in the block storage arrangement for the first time. In the case of an empty container, it is assumed that the center of gravity lies with the center point in the horizontal extension of the container. With the device for determining a container loading center of gravity, it is also possible to check whether or not the container meets desired specifications within specified tolerances.

Preferably, the device for determining a container loading center of gravity has an optical recording device. For example, the optical recording device can detect how objects are distributed in the container. For example, if the optical recording device determines that all objects are concentrated in one corner of the container, it can emit a warning signal. The optical recording device can be provided as an alternative or in addition to the weighing devices.

With a method of the type mentioned above, the object is achieved by determining a container loading center of gravity of the container before the container is stored in a container receiving chamber.

If the container loading center of gravity is determined and it is found that such container loading center of gravity is outside of an additional region, an alarm signal can then be generated to alert an operator that the loading of the container needs to be checked and changed if necessary.

Preferably, a container receiving chamber is selected as a function of the container loading center of gravity that is determined. This is particularly advantageous if the block storage arrangement is loaded from below in the direction of gravity, i.e., if a loading chamber, in which the loading vehicle is moved, is arranged below the container receiving chambers. The containers are then inserted from below through a holding device into the respective container receiving chamber. The holding device then holds the container and, if necessary, a stack of containers. If the container loading center of gravity is arranged outside a permitted region, there is a risk that one part of the holding device will be more heavily loaded than other parts of the holding device. If multiple containers in the stack have the same or a similar position of the container loading center of gravity, this can lead to the overloading of such part of the holding device and/or the lowermost container of a stack. Accordingly, a container receiving chamber is selected in such a way that the overloading of a part of the holding device or of the lowermost container is avoided and the weight force of the containers on the holding device of the container is distributed as evenly as possible to all parts of the holding device. To be sure, an exact equal distribution cannot be achieved. However, it is possible to ensure that the force acting on a part of the holding device does not lead to an overloading of such part. If such an overloading becomes apparent because the container to be stored has a container loading center of gravity that, together with the container loading centers of gravity of already stored containers, would lead to an overloading, another container receiving chamber is selected.

Preferably, the container loading center of gravity is determined each time before the container is stored in a container receiving chamber. The assumption here is that, in most cases, the loading state of the container has changed before the container is stored in the container receiving chamber. By determining the center of gravity of the container load each time, one can ensure that the risk of the container stack tilting is minimized. In some circumstances, when restacking containers from one container receiving chamber to another container receiving chamber, it may not be necessary to determine the container loading center of gravity, especially if the information regarding the container loading center of gravity has already been stored. In some cases, however, a determination of the container loading center of gravity will be made even in such case, in order to ensure that the total container loading centers of gravity in a container stack in a container receiving chamber are within permissible limits. In such a case, it can be advantageous if the device for determining a container loading center of gravity is arranged on the loading vehicle.

Preferably, the container loading center of gravity is determined by determining a weight force at multiple different positions on the container. By determining the weight force at multiple different positions of the container in the horizontal direction, it is easy to determine the container loading center of gravity.

Preferably, a total mass of the container is determined. If, in any event, one determines the weight force at multiple different positions of the container, one can also determine the total mass of the container by adding such weight forces. It is thus possible to avoid the overloading of the holding device at the lower end of a container receiving chamber.

Preferably, the center of gravity of the container load is determined optically. In such a case, for example, a camera or the like can be used to check how the load, usually multiple objects, are distributed in the container. If there is an impermissible concentration outside the center of the container (in the horizontal plane), a warning signal can be generated. The optical determination can be carried out as an alternative or in addition to the determination of the weight forces.

Preferably, an eccentricity of the container loading center of gravity is determined and a container receiving chamber is selected as a function of the eccentricity that is determined. Eccentricity provides a simple measurement that can be used to minimize the risk of the tilting of the container stack or the overloading of any part of a holding device.

Embodiments are directed to a block storage arrangement that includes multiple container receiving chambers; at least one container; and at least one loading vehicle, which is movable in a loading direction to the multiple container receiving chambers, includes a container receiver for the at least one container. Upstream of the multiple container receiving chambers in the loading direction, a container loading center of gravity of the at least one container is determined.

According to embodiments, the determination of the center of gravity of the at least one container can include determining a loading eccentricity of the at least one container.

In accordance with other embodiments, the determination of the center of gravity of the at least one container may include a determination of a mass of the at least one container.

In other embodiments, one of the multiple container receiving chambers can be selected for loading with the at least one container as a function of the determined container loading center of gravity.

According to further embodiments, the block storage arrangement can include a device for determining the container loading center of gravity, which is arranged upstream of the container receiving chambers in the loading direction. The device for determining a container loading center of gravity can be configured to determine a loading eccentricity of the at least one container. Further, the device for determining a container loading center of gravity may be configured to determine a mass of the at least one container. The block storage arrangement may also include a control device that is coupled to the device for determining a container loading center of gravity, the control device being configured to select a container receiving chamber as a function of an output signal from the device for determining a container loading center of gravity. Moreover, the device for determining a container loading center of gravity can include at least three weighing devices arranged at a distance from one another, and may further include four weighing devices, which are assigned to corners of the at least one container. The device for determining a container loading center of gravity may be arranged one of in a work or transfer station or on the loading vehicle. Further, the device for determining a container loading center of gravity can include an optical recording device.

Embodiments are directed to a method for operating a block storage arrangement having multiple container receiving chambers and at least one loading vehicle, which is moved in a loading direction to the container receiving chambers, the method including transporting at least one container into one of the multiple container receiving chambers; and determining a container loading center of gravity of the at least one container before the at least one container is stored in the one container receiving chamber.

According to embodiments, the one container receiving chamber may be selected as a function of the determined container loading center of gravity.

In accordance with embodiments, before each at least one container is transported to the multiple receiving chambers, the container loading center of gravity of each at least one container can be determined.

In other embodiments, the determining of the container loading center of gravity may include determining a weight force at multiple different positions on the at least one container. From the determining of the weight force at multiple positions on the at least one container, a total mass of the at least one container can be determined.

According to still other embodiments, the container loading center of gravity of the at least one container load may be determined optically.

In accordance with still yet other embodiments, the method may further include determining an eccentricity of the container loading center of gravity of the at least one container; and selecting the one container receiving chamber as a function of the determined eccentricity.

Other exemplary embodiments and advantages of the present invention may be ascertained by reviewing the present disclosure and the accompanying drawing.

### BRIEF DESCRIPTION OF THE DRAWINGS

The invention is described below with reference to preferred embodiments in conjunction with the drawings. In the figures:

FIG. 1 shows a schematic representation of a stacking storage arrangement;

FIG. 2 shows a schematic plan view of a stacking storage arrangement; and

FIG. 3 shows an alternative embodiment of a work station.

### DETAILED DESCRIPTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

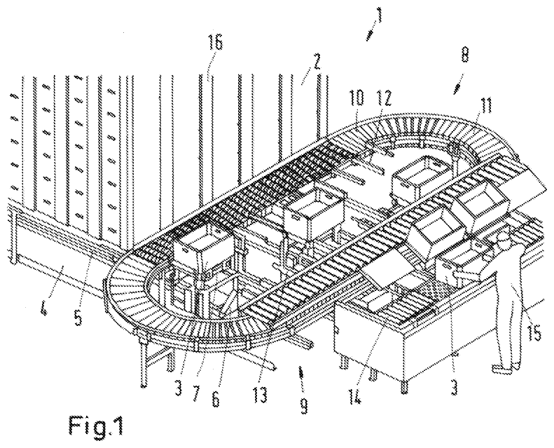

FIG. 1 shows, in schematic form, a stacking storage arrangement 1 with multiple container receiving chambers 2, in which containers or bins 3 can be stored in stacks. The stacking storage arrangement 1 has multiple such container receiving chambers 2, which may be arranged in the form of a matrix having rows and columns. For example, live columns and sixteen rows can be provided to accommodate a total of eighty stacks of containers 3.

The containers 3 are inserted into the respective container receiving chamber 2 from below and are also removed from the respective container receiving chamber 2 from below. A loading chamber 4 is arranged below the container receiving chambers 2 in the direction of gravity. A holding arrangement 5 is provided between the loading chamber 4 and the container receiving chambers 2, of which only one frame is shown here. The holding arrangement 5 has a holding device for each container receiving chamber 2, which can, for example, have multiple holding pawls, which hold the respective lowermost container of a stack and prevent the movement of the lowermost container and thus the movement of the stack in the loading chamber 4.

If a container 3 is to be stored in a container receiving chamber 2, such container 3 is moved into the loading chamber 4 by a loading vehicle 6. If the loading vehicle 6 has reached a position below a container receiving chamber 2 into which the container 3 to be stored is to be stored, a container receiver 7 of the loading vehicle 6 is raised, and this until the container 3 to be stored comes into contact with the lowermost container of a stack. The container receiver 7 is further raised and then lifts not only the container 3 to be stored, but also the stack of the remaining containers held within the respective receiving chamber 2. Such lifting takes place until the container 3 to be stored has been moved past the holding device. Subsequently, the entire stack, including the container to be stored, is lowered until the holding device engages with the newly stored container and holds it in place.

When a container is removed, the loading vehicle 6 is moved again to a position below the container stack. The container receiver 7 is lifted until it comes into contact with the container to be removed. The container receiver 7 is further raised and then lifts the entire stack within the respective receiving chamber 2, and continues to do so until the container to be removed is released from the holding device. The holding device is then released, for example by pivoting holding pawls of the holding device up and out of the path of movement of the container, in other words into a release position. The holding device is then held open until the container to be removed has been moved into the loading chamber 4 by lowering the container receiver. The holding device is then reactivated, such that the holding device can again hold the lower container of the remaining stack within the respective receiving chamber 2. The loading vehicle 6, three of which are shown in FIG. 1, then conveys the containers 3 in a lowered position from the loading chamber 4 to a work station 8.

A work station 8 is arranged outside the container receiving chambers 2. The work station 8 has a transfer region 9 in which at least one transport device 10 is arranged, which is guided in a circulation and has multiple driven rollers 11. The loading vehicle 6 can then transfer the respective container 3 to the transport device 10 or take over a container 3 from the transport device 10, for which transfer fingers 12, 13 are provided. It is possible to move the respective container 3 on the transport device 10 over the entire circulation. This makes it possible to transport the container 3 to a handling station 14, which is a component of the work station 8, and in which an operator 15 has access to the container 3 in order to, e.g., remove goods or objects therefrom or to insert such goods or objects into the container 3. The work station 8 can also be used to store a container 3 in the block storage arrangement 1 for the first time.

The work station 8 can also be constructed in other ways. If containers are loaded and unloaded at a different position, the work station 8 can also be replaced by a transfer station, in which containers are transferred from a conveyor system to the block storage arrangement. In the following discussion, reference to a work station 8 can also be understood as reference to a transfer station.

If one or more objects or products are stored in the container 3, there is a risk that they will be unevenly arranged/distributed in the container 3, such that the center of gravity of the container, which is hereinafter referred to as the “container loading center of gravity,” does not coincide with the center of mass of the container 3 and therefore will be off-center. In general, this is not yet critical when considering only a single container 3. However, if multiple containers are stacked on top of one another in the direction of gravity and the container loading center of gravity in all containers deviates in the same direction from the horizontal center of the container 3, there is a risk that the container stack 3 will tilt and act with impermissibly high lateral forces on the posts 16, which are arranged at the corners of the container stacking chambers 2 and delimit the container stacking chambers, if necessary with cross members located between the posts 16. On the other hand, there is a risk that the holding device 5 of a container stacking chamber 2 will be unevenly loaded. For example, if the holding device 5 of a container stacking chamber 2 has four holding pawls arranged in the region of the four corners of the container stacking chamber 2 and the container loading centers of gravity of all containers are arranged in one corner, then most of the weight force exerted by the container stack on the holding device 5 acts on the holding pawl in such corner. This can lead to the holding pawl being overloaded and ultimately losing its function or being damaged. In such a case, there is also a risk that the lower container of a stack will be overloaded and damaged at an edge or corner.

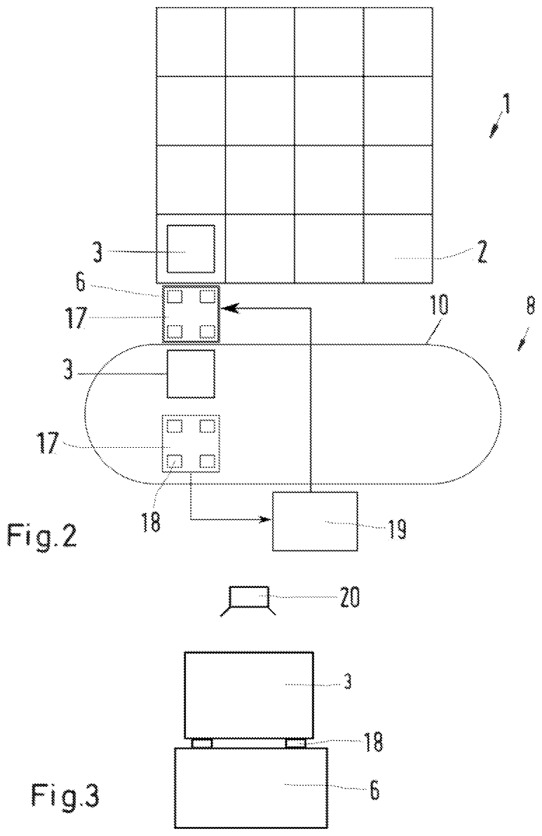

To minimize the risk of damage to or malfunction of the block storage arrangement 1, a device 17 for determining a container loading center of gravity is provided, as shown schematically in FIGS. 2 and 3, which is arranged in front of the container receiving chambers 2 in a loading direction from the work station 8 to the container receiving chambers 2. Thus, the device 17 for determining a container loading center of gravity can detect or sense a container loading center of gravity before the container 3 is stored in the container receiving chamber 2.

Thereby, the device 17 for determining a container loading center of gravity can be arranged in the work station 8, for example in the region of the transport device 10, as shown in FIG. 2. However, it can also be arranged on the loading vehicle 6 or at any other location through which a container 3 must pass before being stored in a container receiving chamber 2.

In the present case, the device 17 for determining a container loading center of gravity has multiple weighing devices in the form of load cells 18. In the present case, four load cells 18, which are assigned to the four corners of a container 3, are provided. Each of the load cells 18 determines a part of the weight force exerted by the container 3, such that the sum of such weight force also allows a statement to be made regarding the mass of the container. Thus, the device 17 for determining a container loading center of gravity preferably also determines a mass of the container 3. The device 17 for determining a container loading center of gravity is connected to a control device 19, which determines the position of the container loading center of gravity from the signals of the load cells 18. Thereby, the control device 19 can also determine the distance from the center of gravity of the container 3 and the direction in which the center of gravity of the container load is away from the horizontal center point of the container 3. Typically, the center of gravity of the container 3 is at the center point in the horizontal direction. One can also use the device 17 for determining a container loading center of gravity to check, when a container 3 is stored in the block storage arrangement 1 for the first time, whether or not the center of gravity of the container 3 is arranged within permissible limits around the center point of the container 3 in the horizontal direction. Control device 19 can include a processor and one or more memory/storage units, provided in control device 19 or externally thereto, can store a set of instructions for determining the distance from the center of gravity of container 3 and the direction in which the center of gravity of the container load is away from the horizontal center point of the container 3 from the container loading center of gravity determined from device 17, such that the processor of the control device 19 is configured to execute the instructions stored in the one or more memory/storage units.

The control device 19 can determine an eccentricity of the container loading center of gravity from the distance, magnitude and the direction of the container loading center of gravity from the center of gravity or center point of the container 3. If the eccentricity exceeds a predetermined limit value, the control device 19 can generate an alarm signal, such that the operator 15 can check the loading of the container 3. The one or more memory/storage units can further include a set of instructions to determine the eccentricity of the container loading center of gravity from the distance, magnitude and the direction of the container loading center of gravity from the center of gravity or center point of the container 3 that is executable by the processor of control device 19.

Preferably, however, the control device 19 is also used for a further object. The control device 19 stores the eccentricities of all containers 3 in a container receiving chamber 2 and can then determine whether or not the eccentricity of a new container 3 to be stored is still permissible. If there are already many containers 3 in a container receiving chamber 2, the eccentricities of which all point in the same direction, the control device 19 will no longer be able to store the new container to be stored in such container receiving chamber 2, but the control device 19 gives the loading vehicle 6 the command to move to another container receiving chamber 2 and store the container 3 there, wherein the newly selected container receiving chamber 2 has a container stack with a permissible total eccentricity that is not changed in an impermissible manner by the eccentricity of the new container 3 to be stored.

Thus, one proceeds as follows:

If a container 3 is loaded or unloaded in the work station, i.e., if a product or an object is stored in or removed from a container 3, the container 3 is passed over the device 17 for determining a container loading center of gravity, and there, with the aid of the control device 19, the position and magnitude of the container loading center of gravity, in other words the eccentricity, are determined. Furthermore, the total mass of the container 3 is determined.

The holding device at the lower end of a container receiving chamber 2 in the direction of gravity is designed for a maximum load, for example 750 kg. Thereby, there is also a maximum displacement of the load center of gravity of the stack of, for example, 75 mm for a dimension of the containers 3 in plan view of 450×650 mm.

The container 3 is thus guided over the device 17 for determining a container loading center of gravity, and there the center of gravity and the mass of the container 3 are determined with the aid of the load cells 18. A possible eccentricity per container 3 can be allowed as function of its weight at the work station 8. The smaller the payload of the container 3, i.e., the mass of the stored objects or products, the greater the permitted eccentricity.

Based on the determined mass and the determined eccentricity, the control device 19 now determines a container receiving chamber 2 into which the container 3 can be moved, without the sum of the eccentricities in relation to the stack weight being outside a certain permissible range. The greater the total stack weight, the smaller the load-specific eccentricity.

A single container is approved for an eccentric center of gravity of approximately 150 mm at maximum loading. If, with the aid of the device 17 for determining a container loading center of gravity, it is determined that, in the case of a container 3, its center of gravity exceeds such value, the operator 15 receives an error message that the loading of the container 3 must be changed.

FIG. 3 shows a modified embodiment. Here, in addition to the load cells 18, an optical recording device 20 is provided, which can look in at a container that is open at the top in the direction of gravity and optically determine how the load of the container 3 is arranged. The optical recording device 20, which can be a digital camera or digital sensor for determining the load distribution by image processing, see, e.g., a 2D machine vision inspector (see https://www.sick.com/de/en/machine-vision/2d-machine-vision/inspector/c/g114860) by Sick AG, can be provided in addition to or as an alternative to the weighing device.

The connection between the control device 19 and the loading vehicle 6 can be made without a wire or with the aid of a signal wire.

In many cases, one will determine the container loading center of gravity of the container 3 prior to each time the container 3 is stored in a container receiving chamber 2, with the exception of so-called “restacking operations.” with which a container 3 is removed from one container receiving chamber 2 and stored in another container receiving chamber 2. This is possible because the control device 19 already has information regarding the eccentricity of the container 3 to be transferred or restacked. The control device 19 can then ensure that an impermissibly high eccentricity of the loading center of gravity of the total stack in a container receiving chamber 2 does not occur, even during a restacking operation. However, it is also possible to provide that a container loading center of gravity is also determined during each restacking operation.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. A block storage arrangement comprising:
multiple container receiving chambers;
at least one container;
at least one loading vehicle, which is movable in a loading direction to the multiple container receiving chambers, includes a container receiver for the at least one container; and
wherein, upstream of the multiple container receiving chambers in the loading direction, a container loading center of gravity of the at least one container is determined.

2. The block storage arrangement according to claim 1, wherein the determination of the center of gravity of the at least one container includes determining a loading eccentricity of the at least one container.

3. The block storage arrangement according to claim 1, wherein the determination of the center of gravity of the at least one container includes a determination of a mass of the at least one container.

4. The block storage arrangement according to claim 1, wherein one of the multiple container receiving chambers is selected for loading with the at least one container as a function of the determined container loading center of gravity.

5. The block storage arrangement according to claim 1, further comprising a device for determining the container loading center of gravity, which is arranged upstream of the container receiving chambers in the loading direction.

6. The block storage arrangement according to claim 5, wherein the device for determining a container loading center of gravity is configured to determine a loading eccentricity of the at least one container.

7. The block storage arrangement according to claim 5, wherein the device for determining a container loading center of gravity is configured to determine a mass of the at least one container.

8. The block storage arrangement according to claim 5, further comprising a control device that is coupled to the device for determining a container loading center of gravity, the control device being configured to select a container receiving chamber as a function of an output signal from the device for determining a container loading center of gravity.

9. The block storage arrangement according to claim 5, wherein the device for determining a container loading center of gravity comprises at least three weighing devices arranged at a distance from one another.

10. The block storage arrangement according to claim 9, wherein the device for determining a container loading center of gravity comprises four weighing devices, which are assigned to corners of the at least one container.

11. The block storage arrangement according to claim 5, wherein the device for determining a container loading center of gravity is arranged one of in a work or transfer station or on the loading vehicle.

12. The block storage arrangement according to claim 5, wherein the device for determining a container loading center of gravity comprises an optical recording device.

13. A method for operating a block storage arrangement having multiple container receiving chambers and at least one loading vehicle, which is moved in a loading direction to the container receiving chambers, comprising:
transporting at least one container into one of the multiple container receiving chambers; and
determining a container loading center of gravity of the at least one container before the at least one container is stored in the one container receiving chamber.

14. The method according to claim 13, wherein the one container receiving chamber is selected as a function of the determined container loading center of gravity.

15. The method according to claim 13, wherein, before each at least one container is transported to the multiple receiving chambers, the container loading center of gravity of each at least one container is determined.

16. The method according to claim 13, wherein the determining of the container loading center of gravity comprises determining a weight force at multiple different positions on the at least one container.

17. The method according to claim 16, wherein, from the determining of the weight force at multiple positions on the at least one container, a total mass of the at least one container is determined.

18. The method according to claim 13, wherein the container loading center of gravity of the at least one container load is determined optically.

19. The method according to claim 13, further comprising:
determining an eccentricity of the container loading center of gravity of the at least one container; and
selecting the one container receiving chamber as a function of the determined eccentricity.
